(19) United States
(12) Patent Application Publication
(10) Pub. No.: US 2003/0079129 A1
(43) Pub. Date: Apr. 24, 2003

(54) Secure delivery or collection system

(76) Inventor: Courtenay Traice Thomas Lindsay, London (GB)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/148,538

(22) PCT Filed: Dec. 4, 2000
(86) PCT No.: PCT/GB00/04646

(30) Foreign Application Priority Data
Dec. 3, 1999 (GB) 9928937.3
Apr. 19, 2000 (GB) 0009557.0

(51) Int. Cl. H04L 9/00

(52) U.S. Cl. 713/176; 705/75

(57) ABSTRACT

A system for delivery or collection of goods from a customer's home comprises a central control system which monitors and controls a plurality of enclosures, each enclosure (1) being protected by releasable locking means or deactivatable alarm means associated with data communication means, e.g. a mobile telephone type unit (4,5,6). The central control system, e.g. a computer (40), generates a new security code for each delivery which is transmitted to the data communication means, and which when subsequently entered into security code input means, e.g. a keypad (6) or an RF tag reader, associated with and accessible from outside the enclosure, affords access to the enclosure enabling a person to deliver or collect an item (50). The central control system may be provided by a delivery service (51,52) and may communicate automatically with the box owner via telephone (20) or mail (PC 30).

This invention relates to secure delivery or collection systems and, in particular, to means for ensuring monitored and secure delivery or collection of goods to desired locations when the location is unmanned.

In recent years, there has been a major increase in the remote ordering and purchasing of all manner of goods. The traditional method of delivery of the goods was via the medium of a parcel sent by the postal authorities or other logistics organisations. In recent years, very substantial businesses have grown up dedicated not to the delivery of mail (though they do happily transport papers as well), but rather to the physical delivery of items of merchandise. Such so-called courier firms operate internationally as well as on a more local delivery basis. With both postal and courier systems, there is traditional reliance on someone being physically present to receive the goods. Although it is entirely possible for small items to be safely delivered via a standard “letterbox”, larger items and/or items of particular value need to be received securely, and many postal administrations operate a delivery service where, if there is no-one to receive the item in question, it is returned to a local office and a message left, usually by way of a card dropped through the letterbox, that something is awaiting collection. Collection is not normally available on a 24 hour basis and the system is generally inconvenient.

In very recent times, the problem of providing secure delivery has been exacerbated due to the substantial and continuous growth of transactions for the purchase of articles via the Internet. Using appropriate financial transaction technology, the supplier of the goods is assured of being paid, normally by way of credit or charge card. However, the physical delivery problems referred to above remain.

According to the present invention there is provided a secure delivery or collection system comprising:

a plurality of secure lockable enclosures,

each enclosure having associated therewith; data communication means,

releasable locking means enabling access to the interior of the enclosure to be obtained,

and security code input means accessible from outside the enclosure and cooperating with the said releasable locking means,

the system further comprising a central control system comprising security code generation means and security code communication means,

whereby for an individual delivery to an enclosure a new security code is generated by the said central control system and communicated to the data communication means of that enclosure,

such that when the said new security code is subsequently entered into the said security code input means associated with the enclosure, the said releasable locking means is triggered affording access to the interior of the enclosure in order to make the said individual delivery.

According to the present invention there is further provided a secure delivery or collection system comprising:

a plurality of enclosures,

each enclosure having associated therewith; data communication means,

de-activatable alarm means comprising an alarm protecting the interior of the enclosure,

and security code input means accessible from outside the enclosure and cooperating with the said de-activatable alarm means,

the system further comprising a central control system comprising security code generation means and security code communication means,

whereby for an individual delivery to an enclosure a new security code is generated by the said central control system and communicated to the data communication means of that enclosure,

such that when the said new security code is subsequently entered into the said security code input means associated with the enclosure, the said de-activatable alarm means is deactivated affording access to the interior of the enclosure without triggering the alarm in order to make the said individual delivery.

Within the general concept of the present invention as outlined above, a wide variety of more or less sophisticated systems may be envisaged. The detailed mechanical construction of appropriately secure enclosures and locking means therefor may be widely varied depending upon considerations such as the degree of security required, space constraint and expense. In this connection, however, very substantial efficiencies may be generated by using as the data communication means a transmitter/receiver means comprising a “mobile telephone” or “pager” style core unit, appropriately interfaced and programmed (for a variety of transmission means for example, cellular, local RF, satellite, cable). Such units benefit from being now mass produced, thus reducing cost, and are able to take advantage of the existing communications infrastructure such as the cellular telephone system network as the medium for the transmission or reception of messages. However, a particular advantage of adopting mobile telephone technology resides in the ability to use a standard mobile telephone keypad for e.g. the entry of a security code and additionally, if desired, to use the screen display of such a system to provide messages to be read by a user. Physically, a mobile telephone unit may be mounted within the secure container with its screen visible via an appropriate viewing aperture and with its keypad accessible by a suitable aperture in the casing of the container. Alternatively, use may be made of dedicated communications units using TCP/IP or other protocols as their communicating protocols.

Procedurally, a transaction may be arranged, for example, as follows:

Following the placement and acceptance of the original order, which may take place by any convenient means such as Internet, telephone or even personal attendance, the supplier of the item or items in question will then make the necessary arrangements to have the item(s) delivered. This may be, for example, via a courier or mail delivery company. The delivery address will normally be available in clear unencoded form and this can be printed on appropriate accompanying paperwork.

By the time the person making the physical delivery arrives at the address, he or she needs to be in possession of a security code, and this can be provided by the central control system in a number of forms. At the point of delivery, the security code is input into the security code input means associated with the enclosure and at some suitable previous time, the security code input means in the enclosure will have been told by the central control system to expect such a security code, i.e. it will have been primed then to enable access. The entry of the security code may be made manually or using any suitable electronic means, for example via a pass card embodying a code, e.g. on a magnetic strip or by way of punched holes. The entry of the security code may be made using a keypad, mobile phone, satellite phone, handheld wireless transmitter, wireless identity keys, tag reader or other suitable device.

When access is achieved, and the enclosure has been opened, the goods deposited therein, and the enclosure re-closed, the enclosure may lock automatically and the security code just used to open it may thereafter be automatically disabled. The security code input means may, of course, have a master security code which does not change to enable the customer to gain access to the goods which have now been delivered. Variations on this mode of operation are easily conceived.

The administration and monitoring of a large number of enclosures comprising delivery or collection boxes (hereinafter referred to as “boxes”) is carried out by a central control system. This can conveniently be done by using mobile phone technology and with a trusted central control system, the suppliers of the goods do not need to be provided directly with the “telephone number” of the data communication means in the enclosure. This can be maintained by the central control system associated with the name and address of the customer who purchases the item to be delivered from a supplier thereof.

The customer tells the supplier to contact the central control system when the item is ready to be delivered, and the supplier can advise the central control system of the means of delivery or collection being employed. The central control system can then communicate with the physical deliverer to provide the necessary security code to open the box. Alternatively the central control system may be provided by an organisation carrying out deliveries to the enclosure.

The central control system can also monitor operation, for example it can be provided with information from the data communication means in the box, to determine when delivery or collection actually occurred and, if desired by the customer, the central control system can then tell the customer that delivery or collection has indeed been effected. A variety of means may be employed to do that, for example conventional telephone land line, a mobile telephone message, or in the case that the customer has e-mail, via e-mail. In all three cases, generation of a “confirmation of delivery or collection” message may be entirely automatic and triggered by the transmission of the data communication means in the box of some form of “transaction report” confirming that the delivery or collection has occurred:

The use of mobile telephone technology in this way brings with it a variety of additional security features. One obvious such feature is that if the entire box is removed and physically transported, the fact that it is being transported can be detected by the mobile phone network control system and the alarm raised. Likewise, any attempt to disable the system may be immediately detected. Furthermore, conventional security devices which, for example, will indicate that an attempt to physically break into the box is being made may automatically trigger the transmission of an alarm signal, such transmission being naturally wholly undetectable to whoever is attempting to gain access to the box. There is, therefore, every possibility that rapid reaction, for example by the police, will enable the tamperer or would-be thief to be immediately apprehended. The central control system may include a monitoring system to track the item's whereabouts as known in secure transport systems.

The enclosure may comprise a secure lockable container which is portable and able to transmit data about its location.

A system in accordance with the invention is illustrated diagrammatically and by way of example of a workable system in the attached drawings in which:

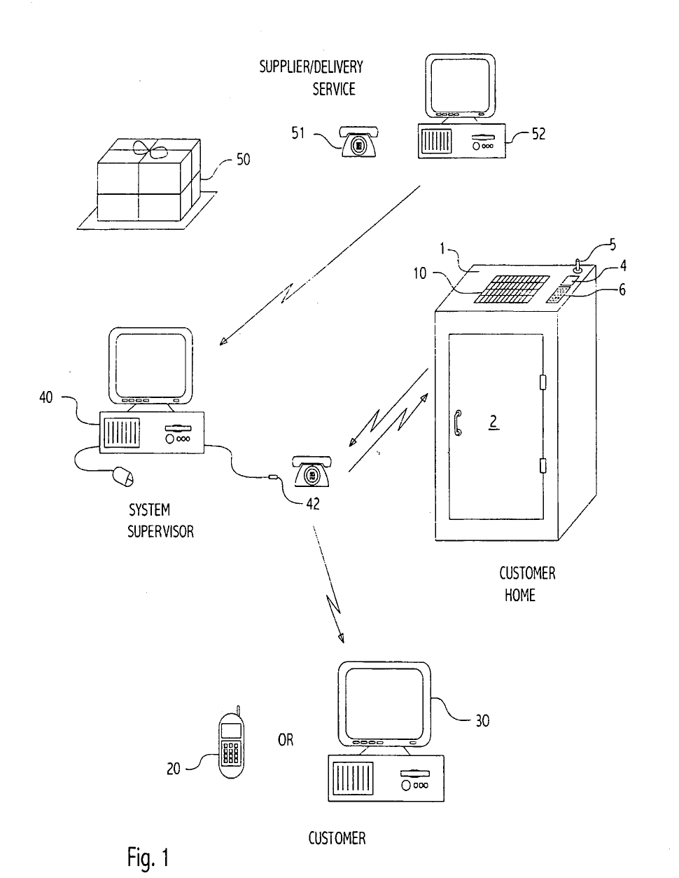

FIG. 1 is a general arrangement of the elements of a first mode of the invention in stylised form;

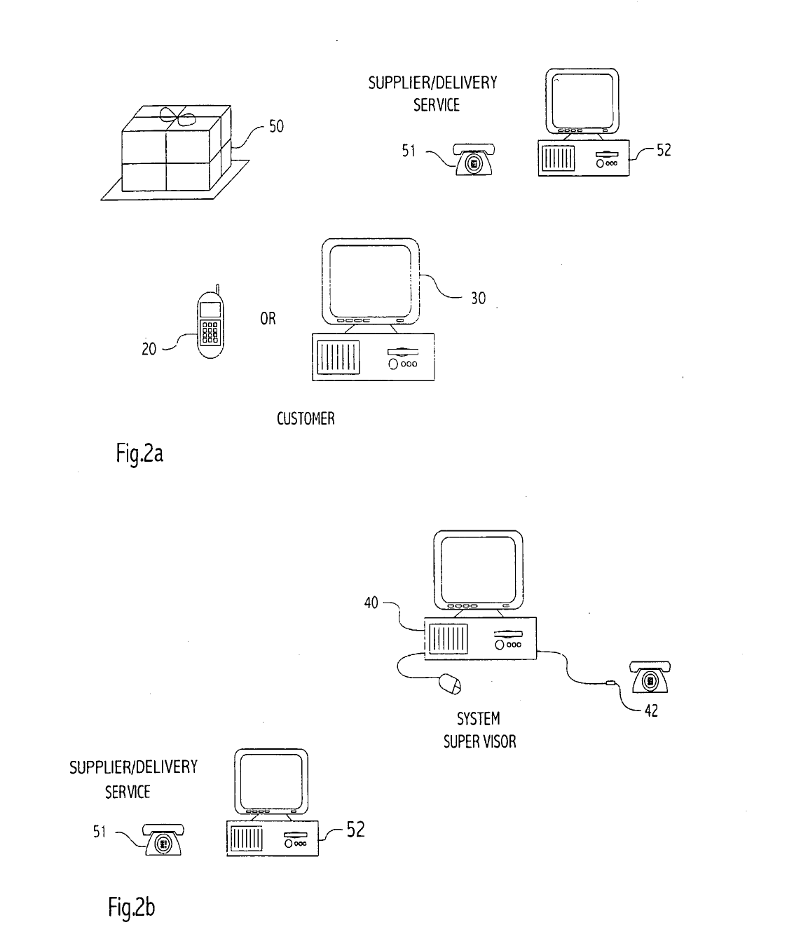

FIGS. 2a, 2b, 2c and 2d are general arrangements of the elements of a further mode of the invention in the sequence of operation;

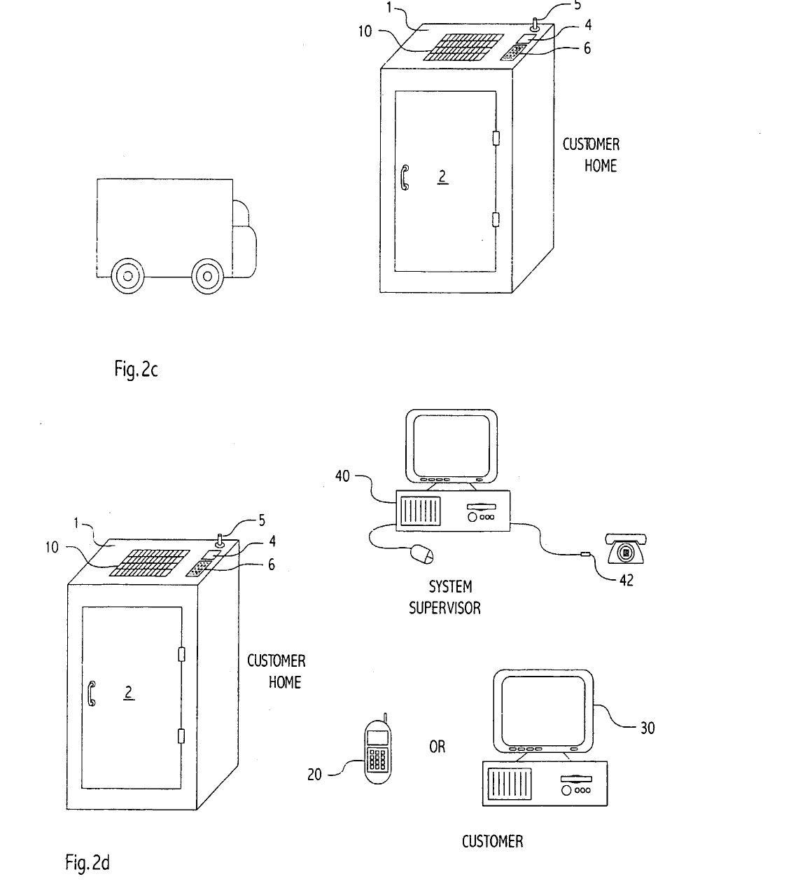

FIGS. 3a and 3b show a further embodiment of the customer's home site in the open and closed position respectively;

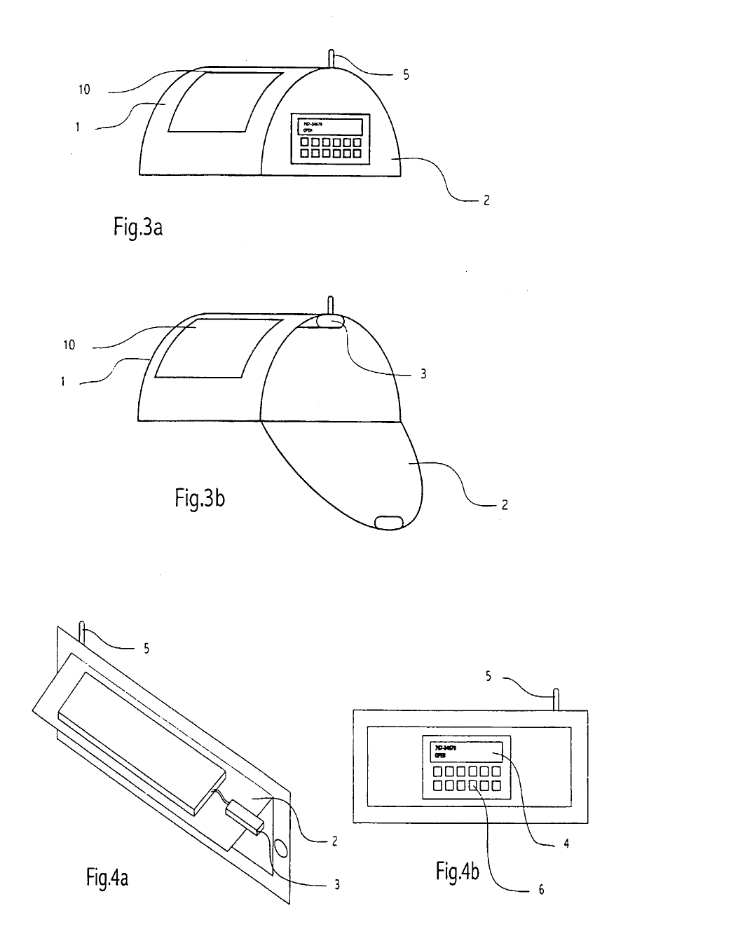

FIGS. 4a and 4b show a further embodiment of the customer's home site in the open and closed position respectively;

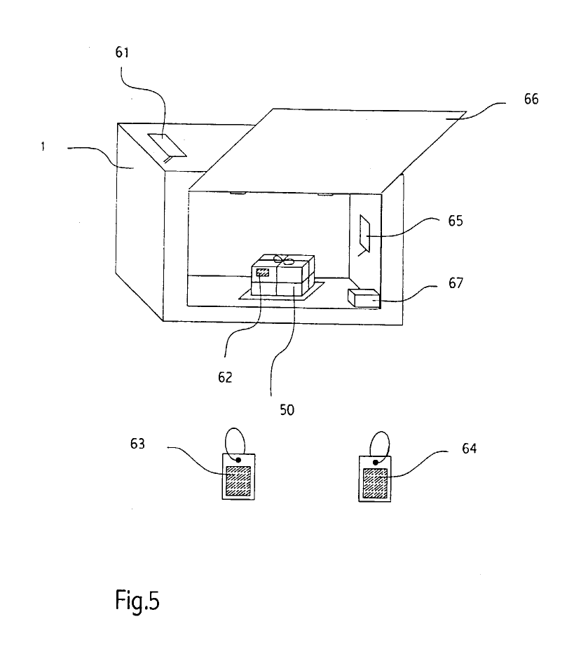

FIG. 5 shows a further embodiment of the customer's home site and releasable locking means; and

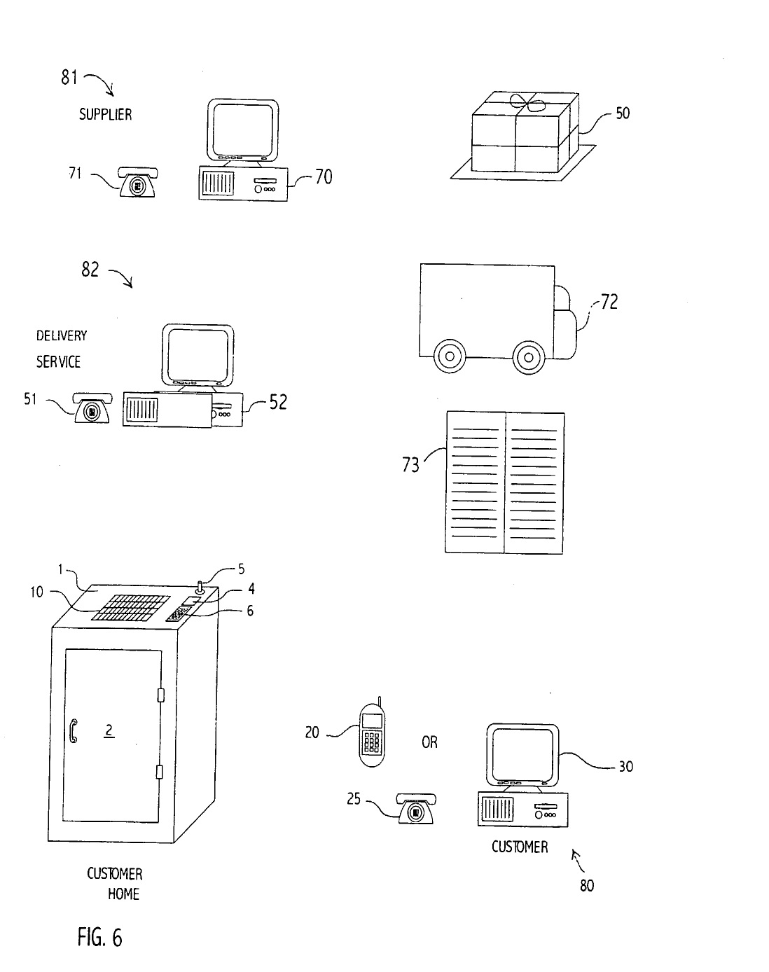

FIG. 6 shows a general arrangement of the elements of a further mode of the invention in stylised form.

Referring to FIG. 1, this shows in very stylised form the essential components of the system and one mode of operation. The diagram is in four parts, viz. the depiction of a secure delivery or collection box located at the customer's home, the customer himself, a central control system, and a supplier or delivery service of or for the respective item. Normally speaking, all four will be at different locations. Thus, located at the customer's home site is a generally block-shaped box 1 having a door 2 which can be opened to allow access to the interior of the box 1, but only when a releasable locking means comprising a concealed locking mechanism (not shown in the drawing) is triggered. This is achieved as explained below by virtue of the fact that mounted within the box 1 is a transmitter/receiver unit having a keypad 6, an antenna 5 and a small internally illuminated screen which can be seen through an aperture 4 just above the keypad. Power may be supplied by a suitable storage battery system kept continuously charged by means of a photo voltaic array 10 set on the top of the box 1.

Looking at the base of the diagram, the customer is provided with a mobile phone 20, or access to a computer with Internet capability 30.

The system of numerous secure boxes of type 1 is administered by a central control system comprising a system administrator who is provided with a PC 40 appropriately programmed and including a telephone interface card connected to a telephone jack 42.

Shown near the top of the diagram is the supplier or delivery service which has contracted with the customer to deliver an item 50 to the customer's home.

The supplier or delivery service then communicates via its telephone 51 or PC 52 with the system administrator in order to organise access to box 1 when the delivery physically occurs, and that communication can usefully include a date and time window during which the delivery will be made, together with details concerning the size of the item 50. The reason for these latter is to ensure that when the supplier or delivery service arrives at the box 1 with the item 50, there is sufficient space within to enable the item 50 to be placed safely therein and the door 2 closed.

The system administrator then generates a new security code for the delivery of the item 50 and communicates the said new security code to the supplier or delivery service.

By virtue of appropriate programming, the PC 40 now sends a data message containing the said new security code and the date and time window within which the delivery will be made, via its plug-in telephone interface card, jack 42 and the normal telephone system to the transmitter/receiver unit in the box 1 which acts like a mobile phone. The programming of that transmitter/receiver unit, however, is internally so arranged that the message sent from computer 40 stores the security code relative to the delivery of the item 50 in an appropriate memory device and additionally stores details of when that security code will be operative. The communication of the security code may, if desired, be encrypted for enhanced security of operation.

Date and time verification means and security code verification means are also provided whereby the security code and the date and time window transmitted to the data communication means may be used to verify a code entered into the security code input means as described hereafter. An alternative arrangement to transmitting a date and time window associated with each security code is for the previous security code to be disabled or deleted when each newly issued security code is received by the transmitter/received unit in box 1.

Once the person physically making the delivery arrives at the customer's home, he or she locates the box 1 and uses the keypad 6 to input the security code, which is then verified by the said security code verification means and the date and time verification means. If the security code is verified and the delivery has taken place within the specified date and time window, the said concealed locking mechanism is then triggered to enable the door 2 to be opened simply by pulling on the handle and the item 50 placed within the box 1. The door 2 is then closed again (or is self-closing).

Security code deletion means may also be provided, for example by means of the internal arrangement of the programming of the said transmitter/receiver unit, whereby the said security code is rendered ineffective after it has been used to obtain access to the enclosure, so that it may not be used to gain access a second time.

The transmitter/receiver unit may be programmed to ensure that the door is closed within a reasonable period of time. If the door is not closed, but left open, with obvious security implications, the transmitter/receiver unit may send, again via the normal mobile phone system, a message to the system administrator.

If, on the other hand, the door closes or is closed within the predetermined time period, the transmitter/receiver unit sends a message back to the system administrator's computer via the mobile phone system which indicates that delivery has successfully been accomplished. This may automatically in pre-programmed fashion trigger advice to the customer that delivery has been effected e.g. via a direct link, for example using a voice chip to synthesise a message, or using the mobile phone paging or short message capability, to the customer's mobile telephone unit 20. Alternatively (or, indeed, additionally), a message may be automatically sent, for example, via standard Internet e-mail from the system administrator's computer 40 to the customer's PC 30.

If appropriate, the confirmation that delivery has been safely effected may also be automatically sent to the computer 52 at the supplier or delivery service.

When the customer arrives back home, he or she may input their master security code into the keypad 6, thus enabling door 2 to be opened and the item or items to be extracted. Once that has occurred, the transmitter/receiver unit may automatically, and again using the mobile telephone network, tell the system administrator's computer 40 that the transaction has been concluded and, at that stage, the computer 40, or rather the programming within that computer, is reset to show that the box is empty.

FIGS. 2a to 2d show the specific steps in a further mode of operation of the invention with the corresponding elements identified with the same numbers as in FIG. 1.

In FIG. 2a the customer makes an order for goods to be delivered to the customer's home. The order may be made on the internet or by e-mail, by mobile or fixedline telephone or indeed in person or by mail. The customer specifies a unique delivery box number of the customer's own delivery box, the customer box code. The supplier processes the order and ships the goods, item 50.

As shown in FIG. 2b, the supplier or delivery service then requests a unique security code, and a supplier or deliverer reference and code from the system administrator to the identified customer's box. The customer's delivery box is then primed to open on input of this security code.

As shown in FIG. 2c the supplier or delivery service arrives at the customer home location with the goods to be delivered. The supplier or delivery service inputs the unique security code and the box 1 is opened to allow access and then relocked. The security code may be input by means of a key-pad 6, or alternatively by means of a wireless reading means located at the customer home site. This wireless reading means will activate and read the delivery code from an wireless identity key such as a wireless RF tag, located on the goods themselves or otherwise available to the delivery person.

It will be obvious that the system just described can be used the other way round, e.g. to ensure secure collection by, for example, a courier company, of an item for despatch from a user's home to a remote destination.

Numerous variations may be made within the scope of the present invention to the specific approach just described. For example, the physical construction of the box may be varied substantially. It may, for example, have a lid on top rather than a door in the side. Instead of being openable by its owner using a master security code, the locking arrangements may comprise a suitable mechanical lock releasable by a conventional physical key. FIGS. 3a and 3b show a further embodiment of the customer home site in which the box is in the form of a conventional US-style mail box with a lockable door 2 which comprises a photo voltaic array 10 and is controllable in one of the ways described above by means of a key pad 6 although it could also be by a wireless activating means. This embodiment also has a door stop 3 which may also include a door open detection means and/or locking means.

Similarly, FIGS. 4a and 4b show the secure enclosure in the form of a conventional letter box system which may be located in an external door or wall and is similarly controlled in one of the ways described above.

The security code input means may alternatively be located remote from the enclosure, and may communicate therewith by means of a conventional hardwire connection, or alternatively via a wireless link, which may be a bluetooth wireless link. This link may conveniently be provided by the data communication means, for example an appropriately programmed and interfaced mobile telephone, associated with the enclosure.

For example, the security code input means may comprise a keypad located adjacent the entrance to the customer's porch or garage, and the enclosure may comprise the interior of the porch or garage area, or alternatively may be a separate container located therewithin.

The security code is then entered into the keypad by the delivery person making the delivery, the releasable locking means being arranged to afford access to the said porch or garage area as well as to any enclosure located therewithin.

Referring now to FIG. 5 a further embodiment is shown in which the enclosure comprises an open space or area which is protected by a deactivatable alarm system and into which an item 50 is delivered. For example, the enclosure might be a yard enclosed by a boundary marking indicating that unauthorised persons should not enter.

The deactivatable alarm system may be activated, for example by means of a proximity detection means such as a proximity sensor which senses the presence of an item tag, for example a passive radio frequency tag, affixed to an item for delivery into the enclosure.

In the embodiment shown the enclosure 1 comprises a container, but could alternatively merely be a defined area of land, and is provided with an active RF transmitting device 61 which detects a passive RF item tag 62 on or with or attached to the item 50. This communication between the RF transmitting device and the RF item tag 62 activates a deactivatable alarm means comprising an alarm system with an RF detector 65 which recognizes the security code on the RF item tag 62. Thus an alarm will sound or be triggered if the item 50 is removed before the RF detector 65 is deactivated. The RF detector is deactivated by a customer key 64 before accessing the enclosure 1 and retrieving the item 50. The supplier or delivery person may also have a service key 63 to deactivate the deactivatable alarm means. The data communication means associated with the enclosure may also notify the customer and the system administrator that the item 50 has been delivered.

In this embodiment a door 66 is provided which stops against a door stop 67 which may also include a door open detection means and/or locking means.

The item tag 62 could include a proximity tag, with a unique security code, attached to the item 50, to enable it to be read, rather like a barcode on items for sale in shops, but working on proximity as opposed to or as well as close-quarters scanning.

On dispatch, the item tag 62 is fitted to the item to be delivered, and the data communication means within the enclosure is notified by the central control system to await reception of the unique security code carried by the said item tag 62 before opening the enclosure. When the tag gets ‘close’ (say 0.1 to 5 meters) the enclosure (which has been primed to accept only the correct security code from the item tag) will automatically unlock (conventionally or electronically).

Then, once inside the box, the item tag is ‘checked in’ by a second reader 65 which resets the enclosure to lock. The data communication means then notifies the customer of delivery, for example, via text messaging. This solves the problem of people stealing goods which have already been delivered into the enclosure.

In all of the above embodiments incorporating a compartment the compartment could be proved with insulation means for keeping the item warm or cold, for example for hot food or ice cream, and also may include additional heating means or cooling means. The compartment may be adapted for a particular type of item.

In a further alternative embodiment the function of the central control system described above is fulfilled by one or more delivery services as shown in FIG. 6, which shows in a stylised form a customer 80, the customer's secure delivery or collection box 1, a delivery service 82, a supplier 81 and goods for delivery comprising an item 50.

Referring to FIG. 6, a customer 80 having means of ordering goods such as a conventional landline telephone 25, mobile telephone 20 or PC with an Internet connection 30 is provided with a secure delivery or collection box 1 as described above and wishes to arrange the delivery of an item 50 from a supplier 81. The supplier may be a shop taking orders in person or by means of a telephone 71, an Internet based vendor taking orders by means of a computer 70, or any other supplier of goods.

The customer first places their order with the supplier, either in person at the shop, over the telephone 20 or 25, by means of the computer 30 or by other convenient means, such as posting a mail order request to the supplier. Alternatively, the customer orders their goods from a delivery service 82 having a telephone 51, Internet connection 52 or other suitable communication means which passes the order on to the supplier of the goods.

The delivery service may be provided by a supplier of goods, such as a supermarket, or by a separate service provider. The delivery service 82 may deliver many items to many customers during a given delivery operation, some of the said customers being equipped with a delivery or collection box and some not being so equipped. The delivery service may also deliver items from more than one supplier to the same customer in the same delivery.

In this way a delivery company may administrate a system comprising many secure delivery and collection boxes, processing orders from its customers for goods from a variety of suppliers and batching up the ordered goods for delivery to each customer's box.

When the item 50 is ready for delivery, the supplier 81 contacts the delivery service 82 and arranges for the delivery service to collect the item 50 from the supplier; if the delivery service is provided by the supplier, the goods are selected by the delivery service from the supplier's stocks.

When the delivery service 82 has prepared a load of items for delivery to its customers, for example by means of a delivery vehicle 72, the delivery service consults a list 73, which may be held on a computer, showing which of its customers are equipped with delivery or collection boxes. It will then see for example that customer 80 has a delivery or collection box 1. The list 73 also contains details of the box 1, including the “telephone number” of the data communication means therein, and additional information such as the space available to receive deliveries and whether the box 1 is currently empty or full.

If there is sufficient space available in the box 1 to receive the item 50, the delivery company 82 then generates a new security code and communicates this security code to the data communication means in the box 1, together with the expected date and time period during which the delivery will be made, and also makes the code available to a delivery person making the delivery. This information is stored in an appropriate memory device so as to prime the box 1 to open as described in the foregoing embodiments when the said security code is input into the code input means associated with the box 1, for example a keypad 6, by the said delivery person delivering the item 50 during the said date and time period.

As described in the foregoing embodiments, a variety of different code input means may be envisaged, including for example a tag affixed to the item 50 and bearing the security code in a form such that it may be electronically read by tag reading means provided instead of or in addition to the keypad 6 when the said tag is proximate to the box 1. For example, the tag may comprise a label bearing a passive radio frequency circuit or alternatively or additionally for example a barcode. The delivery service 82 may then be provided with a roll of adhesive tags each bearing a new security code, and for each delivery of an item to a delivery or collection box, a new tag may be first scanned by a reading device and the security code thereon transmitted to the delivery or collection box for which the item is intended, and the tag then affixed to the item for delivery thereto.

Where the box 1 further provides heating or cooling means as described above, details of the heating or refrigeration requirements of item 50 may also be communicated to the said data communication means within the box 1 together with the security code in order to prime the box 1 to actuate the said heating or cooling means on or prior to the delivery of the item 50.

1. A secure delivery or collection system comprising a central control system,
together with at least one secure lockable enclosure (1),
and at least one coded tag (62),
the coded tag being affixed to an item (50) to be delivered to the enclosure;
the enclosure having associated therewith; data communication means,
releasable locking means (67) controlling access to the interior of the enclosure,
and first sensing means (61) cooperating with the data communication means for sensing and identifying the coded tag;
the central control system generating a security code corresponding to the coded tag and transmitting the security code to the data communication means,
the first sensing means (61) comparing the tag with the security code so as to identify the tag, and cooperating with the releasable locking means to unlock the enclosure to receive the item;
and characterised in that there are further provided second sensing means (65),
the second sensing means identifying the tag (62) and sensing its presence within the enclosure (1).

2. A secure delivery or collection system comprising a central control system,
together with at least one enclosure (1),
and at least one coded tag (62),
the coded tag being affixed to an item (50) to be delivered to the enclosure;
the enclosure having associated therewith; data communication means,
deactivatable alarm means controlling access to the interior of the enclosure,
and first sensing means (61) cooperating with the data communication means for sensing and identifying the coded tag;
the central control system generating a security code corresponding to the coded tag and transmitting the security code to the data communication means,
the first sensing means (61) comparing the tag with the security code so as to identify the tag, and deactivating the alarm means to afford access to the enclosure to deliver the item;
and characterised in that there are further provided second sensing means (65),
the second sensing means identifying the tag (62) and sensing its presence within the enclosure (1).

3. A secure delivery or collection system according to claim 1, characterised in that the second sensing means (65) cooperates with the releasable locking means (67) to lock the enclosure (1) when the tag (62) is placed therein.

4. A secure delivery or collection system according to claim 2, characterised in that the second sensing means (65) activates the alarm means to secure the enclosure (1) when the tag (62) is placed therein.

5. A system according to either of claims 1 or 2 characterised in that the tag (62) is a radio frequency tag.

6. A system according to either of claims 1 or 2 characterised in that the first sensing means (61) is separate from the said enclosure (1).

7. A system according to either of claims 1 or 2 characterised in that the data communication means is adapted to monitor the operation of the sensing means (61, 65) and thus to monitor access to the enclosure (1), and to transmit information derived from such monitoring to the central control system.

8. A system according to either of claims 1 or 2 characterised in that the data communication means comprises a “pager” style core unit for receiving data communications, appropriately interfaced and programmed.

9. A system according to either of claims 1 or 2 characterised in that the data communication means comprises a “mobile telephone” style core unit for transmitting and receiving data communications, appropriately interfaced and programmed and mounted within the enclosure (1).

10. A system according to claim 2 characterised in that the enclosure defines an open collection or delivery space.

11. A system according to either of claims 1 or 2 characterised in that the system further comprises a delivery organisation,
the delivery organisation performing deliveries to a plurality of customers, some of whom have a said enclosure (1) and some of whom do not.

12. A system according to either of claims 1 or 2 characterised in that the system further comprises a delivery organisation,
and the delivery organisation makes a delivery to the enclosure (1) which comprises goods from more than one supplier of goods.
